(19) United States
(12) Patent Application Publication
(10) Pub. No.: US 2010/0122423 A1
(43) Pub. Date: May 20, 2010

(54) Device for Simultaneously Cleaning and Deburring Pipe

(76) Inventor: James Lozar, Johnstown, CO (US)

Correspondence Address: KRAJEC PATENT OFFICES, LLC, 820 WELCH AVENUE, BERTHOUD, CO, 80513, US

(21) Appl. No.: 12/622,522

(22) Filed: Nov. 20, 2009

Related U.S. Application Data
(60) Provisional application No. 61/116,539, filed on Nov. 20, 2008.

(51) Int. Cl. B08B 9/02; B23D 77/00; B23B 5/16

(52) U.S. Cl. 15/104.04; 408/227; 15/106

(57) ABSTRACT

A tool simultaneously deburrs and cleans an end of a pipe. The tool may have a casing that combines a mechanically abrasive cleaning mechanism and a cutting mechanism. The casing may have the cleaning mechanism and cutting mechanism aligned on an axis with the pipe, so that the outer surface of the pipe may be cleaned while the internal diameter may be cut or deburred. Some embodiments may be hand held devices that may be gripped in the palm of a hand, while other embodiments may be mounted on a drill or other powered mechanism.

### CROSS REFERENCE TO RELATED APPLICATIONS

This patent application claims priority to and benefit of U.S. Provisional Patent Application 61/116,539 filed 20 Nov. 2008 by James K. Lozar, the entire contents of which are hereby expressly incorporated by reference.

### BACKGROUND

Cutting a section of many types of pipe may leave excess material at the ends of the pipe. The edges may be rough and some methods of pipe cutting may leave the end of the pipe with a decreased diameter from the original diameter of the pipe. The internal burr or deformation may be removed prior to joining the pipe in some applications, such as for water pipe where the burr may cause cavitation and premature failure of a fitting or other component.

Brazing or sweating pipe, such as copper plumbing pipe, is usually performed after cleaning the surfaces to be joined. Abrasion is one mechanism by which an oxidized surface may be removed to expose a base metal to be joined.

### SUMMARY

A tool simultaneously deburrs and cleans an end of a pipe. The tool may have a casing that combines a mechanically abrasive cleaning mechanism and a cutting mechanism. The casing may have the cleaning mechanism and cutting mechanism aligned on an axis with the pipe, so that the outer surface of the pipe may be cleaned while the internal diameter may be cut or deburred. Some embodiments may be hand held devices that may be gripped in the palm of a hand, while other embodiments may be mounted on a drill or other powered mechanism.

### BRIEF DESCRIPTION OF THE DRAWINGS

In the drawings,

FIG. 1 is a perspective view of an embodiment showing a pipe cleaning and cutting mechanism.

FIG. 2 is an exploded perspective view an embodiment showing a pipe cleaning and cutting mechanism.

FIG. 3 is a perspective view of an embodiment of a pipe cleaning and cutting mechanism.

### DETAILED DESCRIPTION

A combination cleaning and cutting device may clean an exterior surface and deburr an interior edge simultaneously by turning the device over an end of a pipe. Such preparation may be used on copper plumbing pipe, for example, prior to brazing or sweating a joint.

One embodiment may be a hand held device that may be grasped in a palm and rotated over an end of a pipe. Another embodiment may be mounted on a drill.

The device may have a casing that is a cylinder inside which a mechanically abrasive mechanism may be mounted. A cutting mechanism may be mounted to an end wall of the cylinder and positioned so that the cutting and cleaning operations may be performed simultaneously.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

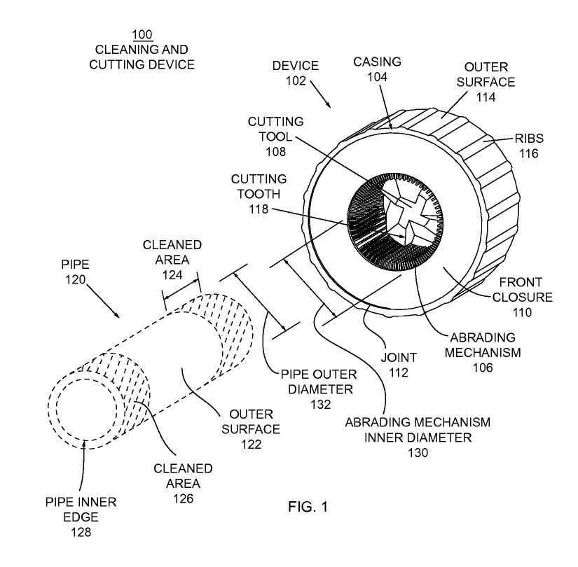

FIG. 1 is a diagram illustration of an embodiment 100 showing a device that may simultaneously clean the external surface of a pipe while cutting an internal surface. Embodiment 100 is an example of a hand held cleaning and cutting device that may be used for preparing copper plumbing pipe, for example.

Embodiment 100 shows a device 102 that has a cleaning function and a cutting function. The cleaning function may abrade the outer surface of a pipe using wire brushes or other abrasion mechanism. The cutting function may cut or debur the inner edge of the pipe. The device 102 may clean the outer surface of a pipe at the same time the deburring or cutting function is being performed, allowing a plumber or other tradesman to quickly prepare a pipe end for use, such as joining to another fitting, pipe section, or machinery.

The combination cleaning and cutting device may be used on a variety of pipe. In plumbing applications, copper pipe is often used for conveying liquid and gas. Domestic water systems may use copper pipe for distributing pressurized water to sinks, tubs, showers, toilets, and other devices. Industrial applications may include using copper pipe for distributing pressurized air or other gasses. Thin walled copper pipe are generally joined using sweated or brazed joints. In sweated or brazed joints, the outer surface of a pipe may be joined to a fitting or pipe section that has a larger inner diameter and may slide over the outer surface of the pipe.

The cleaning process prior to sweating a pipe joint is used to remove dirt, oxides, and other contamination that may adversely affect the sweating or brazing operation. In many sweating or brazing operations, contamination may cause the sweating or brazing operation to be incomplete, have voids, or fail.

The deburring process with copper pipes may remove burrs on the internal diameter edge of a cut pipe. Copper pipe may be cut using pipe cutters that may have a cutting wheel that is rolled around the outer diameter of the pipe while applying a squeezing or clamping force. Such pipe cutters may deform the pipe until failure, producing a cut without producing chips or shavings. In many cases, the inner diameter of the pipe from such a cut may be less than the normal inner diameter of the pipe, and the inner edge may be sharp.

Copper pipe may also be cut using a hacksaw or other type of saw that may cut through the wall of the pipe with a series of cutting teeth. The result of such a cutting operation may be a burrs, chips, shavings, and other bits of copper pipe attached to the joint, along with sharp edges.

The deburring process may prepare a pipe end for joining by removing the burrs, chips, shavings, or other debris that may be attached to the end of the pipe and may further create a chamfer or smoothed edge. The chamfer or smoothed edge may allow fluids or gasses to pass through the pipe smoothly and may remove any deformed edges that may restrict flow.

For water and fluid applications, deburring the inner edge of a pipe may reduce cavitation when a liquid flows through the pipe. In many jurisdictions, a local plumbing code may dictate that all water or fluid joints will have the inner surface of a joint deburred and chamfered.

Other plumbing applications may include applications where pipes are joined using threaded joints. The device 102 may clean the threaded external portion of a pipe after the threads are cut, or may be used to clean a pipe end prior to cutting threads on the pipe. Threaded pipe may be in the form of ductile iron, steel, galvanized steel, stainless steel, aluminum, copper, or other metals.

In electrical applications, galvanized pipe may be used for conduit. The device 102 may be useful in cleaning the outer surface of conduit prior to joining to fittings. In some electrical applications, the outer surface may be cleaned to create a contact area for an electrical connection, such as a ground connection. The internal cutting mechanism may deburr the edges of the conduit so that wires and cables pulled through the conduit are not abraded by the edge of the conduit.

The device 102 may be used to prepare plastic pipe for joining. The device 102 may abrade the outer surface of a pipe so that an adhesive may act on the plastic pipe without contaminants, while the cutting operation may remove any burrs debris from the internal edge where a fluid or gas may flow.

The device 102 may be designed to operate on a single size of pipe. When different sizes of pipe are to be cleaned, different sizes of the device 102 may be used. Some embodiments may include a set of devices 102 that may include two, three, or more sizes of devices 102 for certain standard sizes of pipe that a tradesman may be using.

Copper pipe, for example, comes in several standard sizes that are commonly used for domestic and industrial applications. For example, copper pipe has standard sizes in ¼ inch, 3/16 inch, ⅜ inch, 5/16 inch, ½ inch, ⅝ inch, ¾ inch, ⅞ inch, 1 inch, and larger sizes. For each standard size, a different sized device 102 may be used.

The device 102 may be comprised of a casing 104, an abrading mechanism 106, and a cutting tool 108. The casing 104 may have a front closure 110 that may capture the abrading mechanism 106 and may be joined by an ultrasonic weld that may produce a joint 112.

In many embodiments, the casing 104 may be a thermoplastic material that may be injection molded. The casing 104 may have an outer surface 114 that has ribs 116 or other gripping features so that a user may grasp and turn the device 102 by hand. Other embodiments may have different hand grip features.

The casing 104 may have an inner surface to which the abrading mechanism 106 may be attached. In some embodiments, the abrading mechanism 106 may be secured to the inner surface by epoxy or other adhesive. Some embodiments may use mechanical features on the inner surface to engage or hold the abrading mechanism 106. Some such features may include a rib or other feature that may prevent the abrading mechanism 106 from slipping or moving while cleaning an outer surface of a pipe. Some embodiments may use both an adhesive and a mechanical engagement feature while other embodiments may use just adhesive or just mechanical engagement features to hold the abrading mechanism 106.

The casing 104 may have a front closure 110 that may secure the abrading mechanism 106 into the casing. The front closure 110 may be a molded thermoplastic part that may be joined to the casing by ultrasonic welding, adhesive bonding, snap fit, or other mechanism. In some embodiments, the front closure 110 may removably attached to the casing 104 by threads or other mechanical feature.

The inner surface may be a cylindrical or other surface that is continuous. In many embodiments, the continuous revolved surface of the casing 104 may give the casing 104 structural integrity and also allow the abrading mechanism 106 to be forced against the outer surface of the pipe 120. The abrading mechanism 106 may have an inner diameter 130 that may be smaller than the outer diameter 132 of the pipe 120. The difference between the inner diameter 130 and outer diameter 132 may force the abrading mechanism 106 to comply and produce resistance on the outer surface of the pipe 120.

The engagement of the pipe 120 into the device 102 may cause some expansion forces to be applied to the abrading mechanism 106. The expansion forces are easily resisted when the casing 104 is continuous, as the expansive forces may be resisted by tension in the hoop stresses of the casing 104.

The inner surface of the casing 104 may be conical or other shaped revolved surface. In some embodiments, the revolved shape may be smaller at the far end of the casing 104 so that more abrasive force may be applied to the pipe 102 near the end of the pipe, for example.

The abrading mechanism 106 may be any type of abrading mechanism, and the abrading mechanism may vary depending on the intended use of the device 102.

The abrading mechanism 106 may be a set of wire bristles like a wire brush. Such an embodiment may have a set of wire bristles attached to a flexible backing. The wire bristle assembly may be rolled into a hoop an inserted into the casing 104 and secured using adhesive, mechanical engagement, or other mechanism. The front closure 110 may be also be used to secure the wire bristle assembly as well.

Other embodiments may use stacked sheets of sandpaper, steel wool, scrubbing pads, abrasive pads, or other abrading mechanisms. In many embodiments, the abrading mechanism may be separately manufactured and assembled into the casing 104. Some embodiments may be manufactured by molding the casing 104 onto the abrading mechanism 106.

The cutting tool 108 may cut the inner edge of the pipe 120 when the device 102 is rotated over an end of the pipe 120.

The cutting tool 108 is illustrated as having four cutting teeth 118. Other embodiments may have different numbers of cutting teeth, including embodiments that may have two, three, four, six, eight, or other numbers of cutting teeth.

In some embodiments, the cutting tool 108 may not have teeth. Such embodiments may have an abrasive cutting tool 108 that may be a stone or other abrasive component.

The cutting tool 108 is illustrated as being capable of cutting an approximate 45 degree chamfer to the inner edge of the pipe 120. Other embodiments may be configured to at different angles, including 15 degree, 30 degree, 60 degree, 75 degree, or other angled chamfers.

In some embodiments, the cutting tool 108 may have curved or other shaped teeth. The shaped teeth may be used to apply a radius or other shape to the inner edge of a pipe 120.

The cutting tool 108 may be manufactured from a suitable material that may cut the material of the pipe 120. For copper pipe, the cutting tool 108 may be manufactured from steel that may or may not be hardened. For steel and other types of pipe, the cutting tool 108 may be manufactured form carbide or other material.

In some embodiments, the cutting tool 108 may be separately manufactured and assembled to the casing 104. A treaded fastener or other mechanism may be used to secure the cutting tool 108 to the casing 104. In some embodiments, a mechanical engagement feature such as a step, post, counterbore, or other feature may be used to mechanically engage and align the cutting tool 108 to the casing 104.

Some embodiments may have the cutting tool 108 molded or formed into the casing 104. For example, a set of cutting blades may be inserted into a mold around which the casing 104 may be formed.

The pipe 120 is illustrated to show how the device 102 may be used. The pipe 120 may be inserted into the device 102 and the device 102 may be rotated. The rotational action of the device 102 with respect to the pipe 120 may cause the cutting tool 108 to cut the inner edge of the pipe 120 while the abrading mechanism 106 cleans the outer surface.

After processing each end of the pipe 120, the pipe 120 may have a cleaned area 124 at the far end and a cleaned area 126 at the near end. The inner edge 128 may be the edge of the pipe 120 that is cut or deburred by the cutting tool 108.

In many embodiments, the length of the cleaned area 124 may be approximately the diameter 132 of the pipe 120. Other embodiments may have a ratio of the diameter to the cleaned length of pipe as 0.5, 0.75, 1.0, 1.25, 1.5, 2.0 or other ratio.

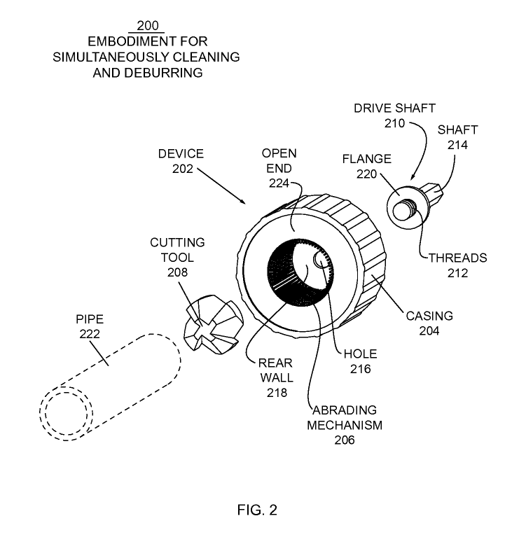

FIG. 2 is a diagram illustration of an embodiment 200 showing an exploded view of a device for simultaneously cutting an inside edge of a pipe while cleaning an exterior surface.

Embodiment 200 is an illustration of an embodiment that may be used manually or with a drill to prepare an end of a pipe. Embodiment 200 may also be an example of an embodiment that is separately manufactured and assembled.

The device 202 of embodiment 200 may comprise a casing 204, and abrading mechanism 206, a cutting tool 208, and a driveshaft 210.

The casing 204 and abrading mechanism 206 may be similar to the casing 104 and abrading mechanism 106 of embodiment 100.

The cutting tool 208 is illustrated exploded from the casing 204. The cutting tool 208 may be assembled to the casing 204 by inserting the cutting tool 208 into the casing 204 so that the cutting tool 208 rests against the rear wall 218. The drive shaft 210 may have external threads 212 that may fit through the hole 216 in the rear wall 218 and engage internal thread in the back of the cutting tool 208.

The driveshaft 210 may have a flange 220 that may rest against the back surface of the rear wall 218 and clamp the cutting tool 208 in place. In some embodiments, the treads 212 may be left hand threads so that the cutting tool 208 may not be loosened during the operation of the device 202 over the pipe 222.

The driveshaft 210 may have a shaft 214 that may extend distal from the open end 224 of the casing 204. The shaft 214 may be mounted in a chuck of a power drill to drive the device 202 and cause the device 202 to rotate around the pipe 222.

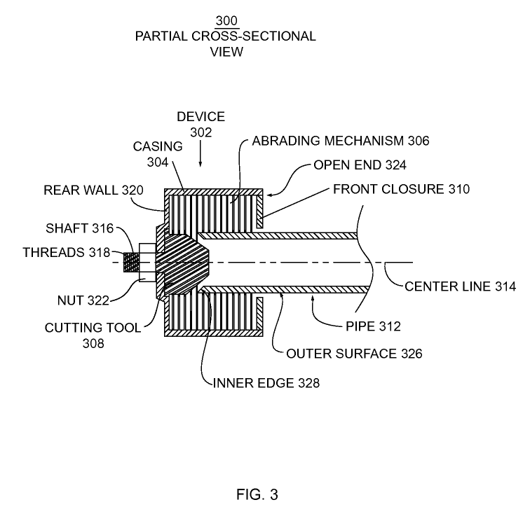

FIG. 3 is a diagram illustration of an embodiment 300 showing a partial cross-sectional view of a device for simultaneously cleaning an outer surface of a pipe and cutting an inner edge of the pipe.

The device 302 may comprise a casing 304, an abrading mechanism 306, and a cutting tool 308. The abrading mechanism 306 may be captured into the casing 304 by a front closure 310, which may be attached to the casing 304.

Each of the components of the device 302 may define an axis that may be aligned with a centerline 314. For example, the casing 304 may be a cylinder having an open end 324 and a closed end with a rear wall 320. The cylinder may be form a center axis around which the cylinder revolves. Similarly, the abrading mechanism 306 may form a cylinder that has a center axis, and the cutting tool 308 may also have a center axis. These components may be assembled such that the axis of each device is approximately collinear with the centerline 314, which may be the centerline of the pipe 312.

In some embodiments, the alignment of each axis may be approximately collinear with the centerline 314. Embodiments that may be used in high speed applications, such as when mounted to a drill motor, may have tighter tolerances in the alignment of the centerline axis. Embodiments that may be used by hand may have looser tolerances for the axis alignment.

The pipe 312 is illustrated in cross section with the outer surface 326 and the inner edge 328 highlighted. The abrading mechanism 306 may engage and clean the outer surface 326 while the inner edge 328 is cut by the cutting tool 308.

The cutting tool 308 is illustrated with a shaft 316 that may have threads 318. The shaft 316 may be integral to the cutting tool 308. A nut 322 may secure the cutting tool 308 to the rear wall 320.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A device comprising:
a casing with an inner surface, a closed end, and an open end, said inner surface having a mechanically abrasive cleaning mechanism configured to clean an outer surface of a pipe;
a cutting mechanism mounted inside said casing configured to cut an inner edge of said pipe, said cutting mechanism being further mounted such that cutting mechanism engages said inner edge of said pipe while said mechanically abrasive cleaning mechanism engages said outer surface.

2. The device of claim 1, said device further comprising a shaft, said shaft being mounted on said closed end.

3. The device of claim 2, said shaft is adapted to be driven by a drill.

4. The device of claim 2, said shaft having a threaded connection to said cutting mechanism.

5. The device of claim 4, said cutting mechanism comprising an internal thread and said shaft comprising an external thread.

6. The device of claim 2, said shaft being comprised in said cutting mechanism and having an externally threaded section, said cutting mechanism being mounted to said casing by a nut attached to said threaded section.

7. The device of claim 1, said casing further comprising said outer surface comprising a frictional element.

8. The device of claim 7, said frictional element comprising a plurality of ridges disposed on said outer surface.

9. The device of claim 1, said mechanically abrasive mechanism comprising wire bristles.

10. The device of claim 9 further comprising a front closure mounted on said open end of said casing and configured to capture said mechanically abrasive mechanism in said casing.

11. The device of claim 10, said casing being made of a thermoplastic.

12. The device of claim 1, said inner surface being cylindrical.

13. The device of claim 1, said cutting tool comprising at least three cutting teeth.

14. A device comprising:
a cutting tool having a first axis, said cutting tool configured to cut an inner edge of said pipe; and
a casing having a first inner diameter defining a second axis, an open end and closed end, said closed end comprising a rear wall, said casing retaining a mechanically abrasive cleaning mechanism along said first inner diameter to clean an outer surface of a pipe;
said mechanically abrasive cleaning mechanism being configured to operate on said pipe simultaneously with said cutting tool.

15. The device of claim 14, said cutting tool being replaceable.

16. The device of claim 14, said pipe being copper pipe.

17. A device comprising:
a casing comprising an inner cylindrical surface and an outer surface, said casing further comprising a closed end;
a mechanically abrasive cleaning mechanism mounted to said inner cylindrical surface, said mechanically abrasive cleaning mechanism comprising a set of wire bristles;
a cutting mechanism mounted to said closed end inside said inner cylindrical surface such that an outer surface of a pipe is cleaned by said mechanically abrasive cleaning mechanism simultaneously with said cutting mechanism cutting an inner diameter of said pipe.

18. The device of claim 17, said outer surface comprising gripping ridges disposed about said outer surface.

19. The device of claim 17, said pipe being copper pipe having a standardized size, said standardized size being at least one of a group composed of:
¼ inch;
⅜ inch;
½ inch;
⅝ inch;
¾ inch;
⅞ inch; and
1 inch.

20. The device of claim 17 further comprising:
a drive shaft mounted to said closed end and extending distal from said open end.
